(19) United States
(12) Patent Application Publication
(10) Pub. No.: US 2004/0162928 A1
(43) Pub. Date: Aug. 19, 2004

(54) High speed multiple ported bus interface reset control system

(75) Inventor: Anthony Joseph Benson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/370,364

(22) Filed: Feb. 18, 2003

(51) Int. Cl. G06F 13/00

(52) U.S. Cl. 710/301

(57) ABSTRACT

A reset control system for a high speed multiple ported bus interface comprises a programmable controller coupled to the bus interface. The controller is capable of detecting the status of the bus interface, determining whether the bus interface is in full or split bus configuration, detecting whether a device is properly connected to the bus interface; and asserting and releasing the reset signal based on the detected interface status, the bus configuration, and the connection status. The controller can also detect when a peer bus interface is removed from a common data bus and assert the reset signal for a fixed or variable amount of time based on the detected interface status, bus configuration, and front end port connection status.

### RELATED APPLICATIONS

The disclosed system and operating method are related to subject matter disclosed in the following co-pending patent applications that are incorporated by reference herein in their entirety: (1) U.S. patent application Ser. No.______, entitled “High Speed Multiple Port Data Bus Interface Architecture”; (2) U.S. patent application Ser. No.______, entitled “High Speed Multiple Ported Bus Interface Control”; (3) U.S. patent application Ser. No.______, entitled “High Speed Multiple Ported Bus Interface Expander Control System”; (4) U.S. patent application Ser. No.______, entitled “High Speed Multiple Ported Bus Interface Port State Identification System”; (5) U.S. patent application Ser. No.______, entitled “System and Method to Monitor Connections to a Device”; and (6) U.S. patent application Ser. No.______, entitled “Interface Connector that Enables Detection of Cable Connection.”

### BACKGROUND

A computing system may be connected to one or more peripheral devices, such as data storage devices, printers, and scanners. In a computing environment, an interface mechanism connects a computing system with the peripheral devices. The interface mechanism typically includes a data communication bus to which the devices and the computing system attach. The communication bus allows the computing system and the peripheral devices to communicate in an orderly manner. One or more communication buses may be utilized in a system.

Typically, a logic chip, known as a bus controller, monitors and manages data transmission between the computing system and the peripheral devices by prioritizing the order and the manner in which said devices take over and access the communication buses. In various interface mechanisms, control rules, also known as communication protocols, are implemented to promote the communication of information between computing systems and peripheral devices. For example, Small Computer System Interface or SCSI (pronounced “scuzzy”) is an interface mechanism that allows for the connection of multiple (e.g., up to 15) peripheral devices to a computing system. SCSI is widely used in computing systems, such as desktop and mainframe computers.

The advantage of SCSI in a desktop computer is that peripheral devices, such as scanners, CDs, DVDs, and Zip drives, as well as hard drives can be added to one SCSI cable chain. The distinct advantage of SCSI is its use in network servers where several hard drives can be easily configured as fault-tolerant clusters. That is, in the event one drive fails, it can be removed from the SCSI bus, and a new one inserted without loss of data even while the system continues to transfer data. A fault-tolerant communication system is generally designed to detect faults, such as power interruption or removal or insertion of peripherals, so that it can reset the appropriate system components to retransmit any lost data.

SCSI peripherals can be also daisy chained together. In a daisy chain environment an intermediate device has two ports. The first port connects to a computing system or another intermediate device attached to a computing system. The first port allows the device to communicate with the computing system. The second port is either terminated (i.e., not attached to anything) or attached to another device and allows for the computing system and the other device to communicate through the intermediate device. Thus, one or more devices can be attached in a line using a SCSI communication bus.

A SCSI communication bus uses the SCSI protocol for data communications. Hardware implementation of a SCSI communication bus is generally done using a 50 conductor flat ribbon or round bundle cable of characteristic impedance of 100 Ohm. Currently, a SCSI communication bus includes a bus controller included on a single expansion board that plugs into the host computing system. The expansion board is referred to as “Bus Controller Card (BCC),” as a “SCSI host adapter,”. or “SCSI controller card.”

In some embodiments, single SCSI host adapters are also available with two controllers that can support up to 30 peripherals. The SCSI host adapters can connect to an enclosure housing multiple devices. In the mid-range to high-end markets, the enclosure may have multiple controller “interface cards” or “controller cards” providing connection paths from the host adapter to SCSI buses resident in the enclosure. These controller cards can also provide bus isolation, configuration, addressing, bus reset, and fault detection functionalities for the enclosure. The controller card provides a connection path from the host adapter to the SCSI buses resident in the enclosure. The controller cards usually provide configuration, addressing, bus reset, and fault detection functionality for the enclosure.

One or more controller cards may be plugged in or unplugged from the backplane while data communication is in process. The insertion and removal of peripheral devices or controller cards to the backplane while the computing system is operating is referred to as “hot plugging.”

Single-ended and high voltage differential (HVD) SCSI interfaces have known strengths and weaknesses. Whereas single ended SCSI devices are less expensive to make, differential SCSI devices can communicate over longer cables and are less susceptible to external noise influences. HVD SCSI has a higher cost associated with it. The 64 milliamp drivers required for differential (HVD) systems draw too much current to be able to drive the bus with a single chip. Single ended SCSI required only 48 milliamp drivers and can be implemented within a single chip. The high cost and low availability of differential SCSI devices also create a need for devices that convert single ended SCSI to differential SCSI such that both device types could coexist on the same bus. Differential SCSI along with its single ended alternative have reached the limits of what would be physically reliable in transfer rates, even though the flexibility of the SCSI protocol allowed for implementing much faster communications. Another problem has been the incompatibility between single ended and differential devices in the same system.

As the amount of data used and stored in systems is ever-increasing, there is a corresponding need to communicate greater quantities of data at ever-increasing speed.

### SUMMARY

In one embodiment, a communication system includes a dual ported bus interface and a controller coupled to the dual ported bus interface. The dual ported bus interface includes first and second front end ports capable of connecting to host bus adapters, first and second expanders coupled to the first and second front end ports, first and second backplane connectors for insertion into a selected slot of first and second slots and coupling to one or more buses on the backplane, and interconnections for coupling signals from the first and second front end ports through the expanders to the backplane buses. The controller includes a programmable code that detects interface status, bus configuration, and connection status of the front end ports; and controls the state of the reset signal based on the detected interface status, bus configuration, and connection status.

The controller includes a feature to detect the interface status from among primary and non-primary states; the bus configuration from between split bus and full bus configurations; and the connection status from between proper and improper.

The controller includes other features to detect the presence of a peer bus interface in the system, and whether the system is configured to allow bus resets.

In one aspect, the controller holds the reset signal when the peer bus interface is removed; the bus resets are enabled; the interface status is non-primary state; and the bus configuration is full bus and connection status is improper. The controller holds the reset signal for a fixed period of time when a peer bus interface is removed and the interface status is primary, the bus configuration is not full bus, or the connection status is proper.

In another aspect, the controller holds the reset signal when the expanders are enabled and the bus configuration is full bus; the connection status is improper; and the status of the interface is primary.

In another embodiment, a dual ported bus interface is provided that comprises first and second front end ports capable of connecting to a host device; first and second expanders coupled to the first and second front end ports; first and second backplane connectors for insertion into a selected slot of first and second slots and coupling to one or more buses on the backplane; and a controller coupled to the first and second expanders for communicating signals from the first and second front end ports through the expanders to the backplane buses. The controller is capable of detecting interface status, bus configuration, and front end port connection status, and capable of holding and releasing a bus reset signal based on the detected interface status, bus configuration, and front end port connection status.

In other aspects, the controller is further capable of detecting peer interface status, and holding and releasing the bus reset signal based on the detected peer interface status. The controller is further capable of detecting: the interface status from among primary and non-primary states; the bus configuration from between split bus and full bus configurations; the connection status from between proper and improper; the presence of a peer bus interface; and whether the system is configured to allow bus resets.

In another aspect, the controller holds the reset signal a peer bus interface is removed; bus resets are allowed; the interface status is non-primary state; and the bus configuration is full bus and connection status is improper. The controller holds the reset signal for a fixed period of time when a peer bus interface is removed and the interface status is primary, the bus configuration is not full bus, or the connection status is proper.

In still another aspect, the controller holds the reset signal when the expanders are enabled and the bus configuration is full bus; the connection status is improper; and the status of the interface is primary.

In another embodiment, a method of asserting a reset signal in a dual ported bus interface comprises: detecting status of the bus interface from among a primary state and a non-primary state; determining a configuration of the bus interface between a full bus configuration and a split bus configuration; detecting status of a connection to the bus interface; and asserting and releasing the reset signal based on the detected interface status, the bus configuration, and the connection status.

In one aspect, the reset signal is asserted when a peer bus interface is removed; the interface status is non-primary state; and the bus configuration is full bus and connection status is improper. The bus reset signal is released after a fixed period of time otherwise upon removal of the peer bus interface.

In another aspect, the method includes asserting the reset signal when expanders on the bus interface are enabled and the bus configuration is full bus; the connection status is improper; and the interface status is primary state.

In another aspect, the method includes detecting the status of a bus reset enable switch; and asserting and releasing the reset signal based on the bus reset enable switch setting.

Various other features and advantages of embodiments of the invention will be more fully understood upon consideration of the detailed description below, taken together with the accompanying figures.

### BRIEF DESCRIPTION OF THE DRAWINGS

FIG. 1A shows a flow diagram of an embodiment of a process for generating a reset signal upon the removal of a peer bus interface card.

FIG. 1B shows a diagram of an embodiment of a state machine for determining whether to assert the reset signal upon a change in status or loss of a connection to a bus interface card

FIG. 2A is a block diagram of a communication system showing an example of a data bus architecture between one or more bus controller cards, peripheral devices, and host computers in accordance with an embodiment of the present invention.

FIG. 2B is a block diagram of an example of interconnections between components included on a bus controller card in accordance with an embodiment of the present invention.

FIG. 2C is a block diagram showing an example of a configuration of components, including monitor circuitry, for the communication system of FIG. 2A.

### DETAILED DESCRIPTION

A data communication system disclosed herein provides high speed data transfer between peripheral devices and host computers via bus controller cards (BCCs). The BCCs are configured to provide the capability to transfer data at very high speeds, such as 160, 320, or more, megabytes per second, and to allow one of the BCCs to assume the data transfer responsibilities of the other BCC when the other BCC is removed or experiences a fault/error condition. To help accomplish this functionality, the BCCs include monitoring circuitry to detect events such as removal or insertion of the other BCC, connection of the BCC to the system, as well as monitor operating status of the other BCC. When a BCC is inserted but experiencing a fault condition, the other BCC can reset the faulted BCC. Under various situations as further described herein, BCCs can include logic components to hold the reset signal to prevent data transfers from being lost or corrupted until the system re-configures and is ready for operation.

Each BCC can communicate with one or more host computers via a front end and with peripherals via a backplane at a back end. A multiple port system can include multiple BCCs. In a specific embodiment, the system is controlled by a dual port BCC designated with primary status. The primary BCC performs functions to avoid data corruption, control common elements in the system, avoid bus contention, and notify a user of incorrect configurations. Other BCCs in the system will have non-primary status, also referred to as peer status, and will respond to bus commands generated by the primary BCC.

Each BCC has a controller that can execute instructions to control the interface; communicate status information and data to host computers via a data bus, such as a SCSI bus; and support diagnostic procedures for various components of the system. Each BCC can also include one or more bus expanders that allow a user to expand the bus capabilities. Although each BCC can be capable of performing functions associated with the primary BCC, the actual functions performed by each BCC depend on its status as a primary or non-primary BCC.

A bus reset signal can be generated in various situations including insertion of a peer BCC in the system; the insertion or removal of a peripheral component; imminent loss of power; loss of term power; improper cabling at the front end of the BCC; and removal of a cable from the front end of the BCC. In some of these situations, a bus reset signal is asserted for a fixed time period, for example, 25 milliseconds.

Some of the above-mentioned situations for asserting the bus reset signal require, however, the reset signal to be held for a variable period of time. One such situation arises when the primary BCC is removed from a system and the system is configured in full bus mode. The remaining BCC assumes primary status, and must reconfigure its expanders to support the full bus configuration. The bus reset signal is held until the reconfiguration is complete to avoid problems associated with the host computers connected to the remaining BCC having access to only half of the peripherals during the time period that only one expander is enabled. Another such situation arises when a cable is not fully connected at the front end of the BCC, which requires the reset signal to be held until the cable is fully connected or disconnected. The reset signal is also held in situations where the system is operating in full bus mode and changes in connections or bus mode configuration switch at the front-end require a different BCC to assume primary status.

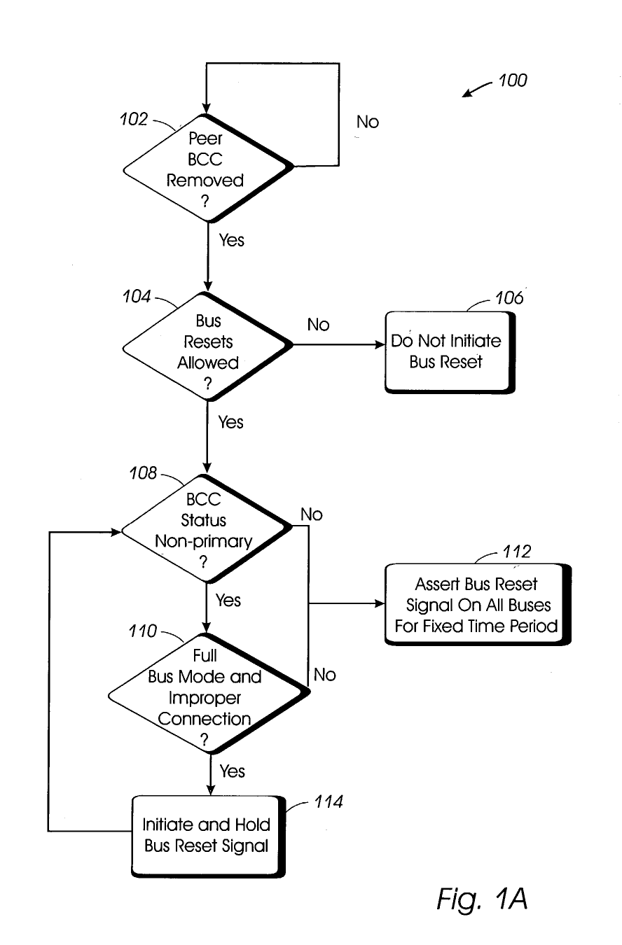

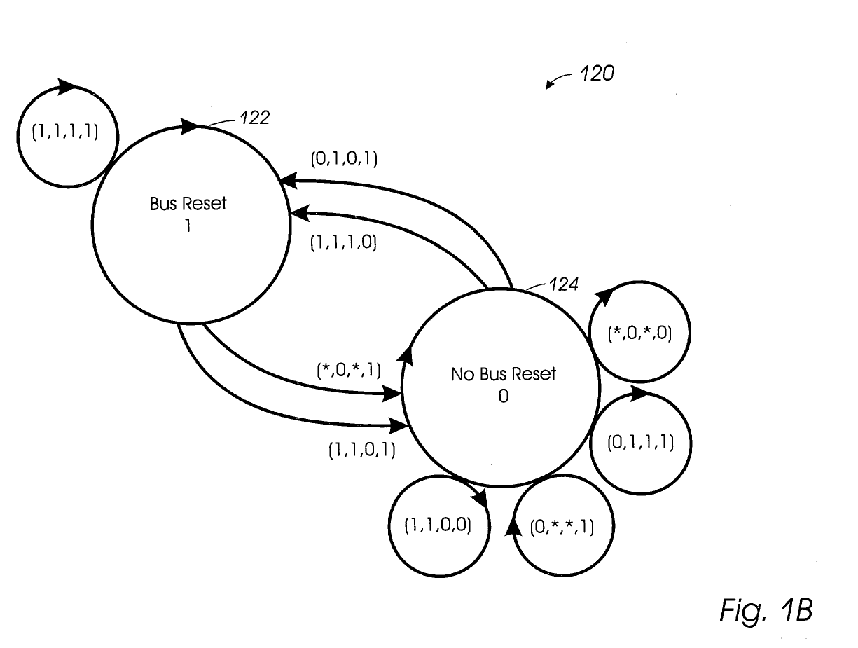

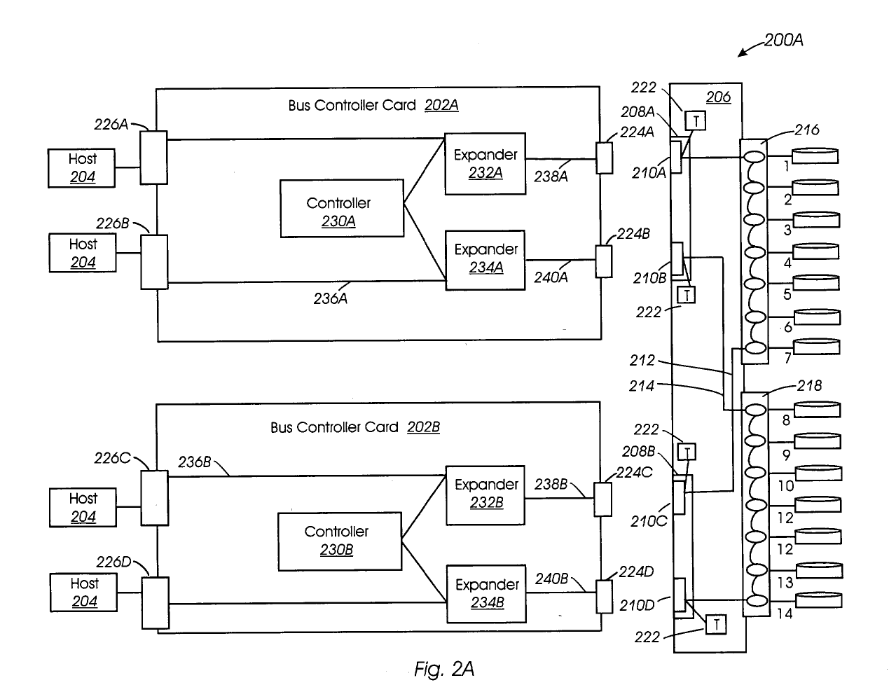

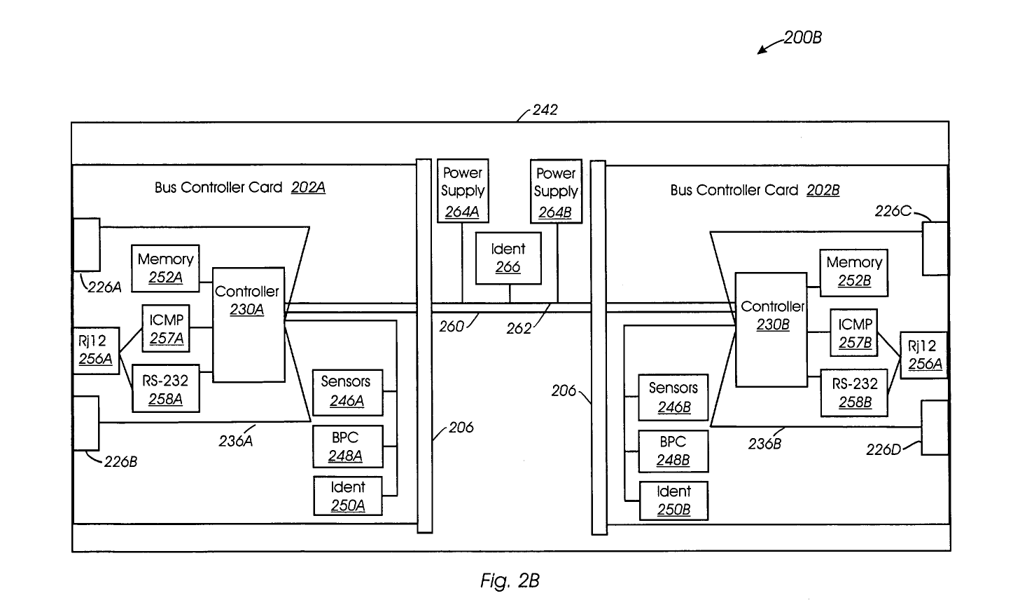

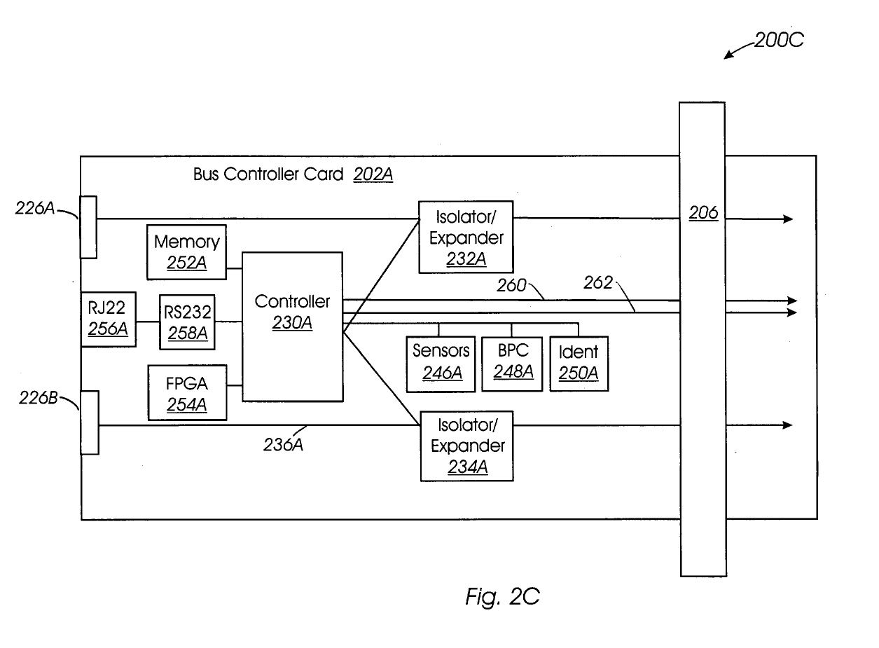

FIG. 1A shows a flow diagram of an embodiment of a reset signal control process 100 for determining whether to hold a bus reset signal for a fixed or variable period of time when a peer card is removed. At the start of process 100, process 102 includes determining whether a peer BCC has been removed. To accomplish this functionality, each BCC detects signals indicating the presence and status of other BCCs in the system. Any suitable method for detecting presence and status of a peer BCC can be utilized in process 102. In some embodiments, a monitor bus between the primary BCC and the peer BCC is provided via the backplane. Each BCC transmits a heartbeat signal to the other BCC via the monitor bus as further described in the discussion of FIG. 2B herein.

If removal of a peer BCC has been detected in process 102, flow control passes to process 104 to determine whether bus resets are allowed by checking the status of configuration indicators in the system. Bus reset signals can be enabled or disabled using any suitable mechanical and/or electronic mechanism, such as dip switches on the BCC that are set manually by a system administrator, or programmed instructions that automatically enable or disable bus reset signals under specified conditions. When bus reset signals are not enabled, flow control transitions to process 106, which prevents a bus reset signal from being initiated.

When a peer BCC has been removed, and bus reset signals are enabled, process 108 determines whether the status of the BCC remaining in the system is non-primary. If the remaining BCC is a non-primary, process 110 determines whether the system is operating in full bus mode and improper connections to the remaining BCC are detected. When the conditions in either process 108 or process 110 are not met, process 112 asserts a bus reset signal on all buses for a fixed time period in response to the removal of a peer BCC in process 102.

SCSI standards specify a term power range between 3.0 volts and 5.25 volts, and a diff_sense signal voltage range between 0.7 volts and 1.9 volts to indicate an LVD connection. The SCSI standards further specify that at least one port be connected to a host computer (not shown) with a HBA that supplies termination, term power, and diff_sense signal. The other port can be connected to another HBA or a terminator (not shown).

Term power and diff_sense are signals that run through ports on the BCC as set forth in the SCSI specification (SP-1 through SP-4). If only one port is connected to an operating Host Bus Adapter (HBA), the term power and diff_sense signals remain although a valid front end connection no longer exists. Accordingly the ports on the BCC are monitored to assure both have valid connections. The ports can have a variety of configurations. A proper connection is one that has at least one port connected to a HBA and the other port connected to a HBA or a terminator device, with valid term power and diff_sense signals. An improper connection has only one port connected. An unconnected connection has none of the ports connected, or both ports connected but no term power available.

When process 108 determines the status of the remaining BCC is non-primary, and process 110 detects the system is operating in full bus mode and the remaining BCC is not properly connected in the system, then process 114 asserts and holds the bus reset signal until either (1) the status of the remaining BCC changes to primary (process 108), or (2) the system is not operating in full bus mode, or proper connections to the BCC are detected (process 110). Upon the occurrence of preceding conditions (1) or (2), flow control transitions to process 112 to assert a bus reset signal on all buses for a fixed time period before the reset signal is released.

Process 114 thus holds the reset signal when a peer BCC is removed and the remaining BCC must assume primary status and enable another expander to maintain the desired configuration, such as full bus mode. When conditions such as an improper connection exist that prevents the reset signal from being released, a visual or audio alarm can be issued to alert an operator to the problem.

Another situation where the reset signal may need to be held for a variable time period can arise when there is a change in the connections or configuration settings that force the primary BCC to relinquish primary status. FIG. 1B shows a diagram of an embodiment of a state machine 120 for determining whether to assert the reset signal upon a change in configuration settings or in a connection to the front end of a BCC that require the BCC to relinquish its primary status. In such situations, the BCC losing primary status holds the reset signal until the peer BCC indicates it has successfully assumed primary status.

The circles and arrows describe how the state of the reset signal moves from one state to another. In general, the circles in a state machine represent a particular value of a state variable. The lines with arrows describe how the state machine transitions from one state to the next state. A boolean expression is associated with each transition line to show the criteria for a transition from one state to another. If the boolean expression is TRUE and the current state is the state at the source of the arrowed line, the state machine will transition to the destination state on the next clock cycle. The conditions for holding and clearing the bus reset signal are shown as a series of 1's and 0's, each of which indicates the corresponding Boolean value of the condition required to transition to or maintain the associated state.

In the example shown for state machine 120, four conditions denoted by (A, B, C, D) correspond to the conditions that are tested to determine whether to transition from or maintain the associated state. In some embodiments, the following conditions are used:

A=1: indicates both expanders are enabled and the system is operating in full bus mode;

B=1: indicates the front end of the BCC is not properly connected;

C=1: indicates the status of the BCC is primary;

D=1: indicates the bus reset signal is currently asserted. A value of zero (0) for A, B, C, or D indicates the corresponding condition is not true. An asterisk (*) in the condition settings indicates that the corresponding condition is not tested in determining whether to transition from or remain in a state.

The bus reset signal is asserted in State 122 (FIG. 1B). The settings of the conditions (A,B,C,D) to remain in State 122 are (1,1,1,1), which means that conditions A through D described above must be true.

Two sets of conditions are shown in FIG. 1B that can cause a transition from State 122 (Bus Reset) to State 124 (No Bus Reset), thereby releasing the reset signal. The first condition is (1,1,0,1), which indicates that the status of the BCC has changed to non-primary. The second condition is (*,0,*,1), which indicates proper connections at the front end of the BCC and a reset signal has been asserted.

In State 124, the bus reset signal is not asserted as long as the conditions (A,B,C,D) remain in one of the following combinations: (*,0,*,0); (0,1,1,1); (0,*,*,1); or (1,1,0,0) as shown in FIG. 1B. The state of the reset signal will transition from State 124 (No Bus Reset) to State 122 (Bus Reset) under certain conditions. In one condition, the reset signal transitions to asserted the when the settings of conditions (A,B,C,D) is (1,1,1,0), which indicates that the expanders are enabled and the system is operating in full bus mode, there is an improper connection at the front end of the BCC, and the card has primary status. In a second condition, the state of the reset signal transitions to State 122 when one of the expanders on the BCC is not enabled or the system is not operating in full bus mode, there is an improper connection at the front end of the BCC, the card does not have primary status, and a reset signal has been asserted, i.e., the conditions (A,B,C,D) are set to (0,1,0,1). Other suitable combinations of conditions can be utilized in other embodiments.

Reset control state machine 120 thus includes determining the status of the connections to the BCC, and holding the reset signal until proper connections are detected.

An example of a system in which the bus reset signal control technique described above can be utilized is shown in FIGS. 2A through 2C, which collectively illustrate a block diagram of data communication system 200 for high speed data transfer between peripheral devices 1 through 14 and host computers 204 via BCCs 202A and 202B.

Referring now to FIG. 2A, BCCs 202A and 202B interface with backplane 206, which is typically a printed circuit board that is installed within other assemblies, such as a chassis (not shown) for housing peripheral devices 1 through 14, as well as BCCs 202A, 202B in some configurations. In certain embodiments, backplane 206 includes interface slots 208A, 208B with connector portions 220A, 220B, and 220C, 220D, respectively, that allow BCCs 202A and 202B to electrically connect to backplane 206.

Interface slots 208A and 208B (also referred to as bus controller slots 208A and 208B) are electrically connected and implemented to interact and communicate with components included on BCCs 202A, 202B and components of backplane 206, as shown. Generally, when multiple peripheral devices and controller cards are included in a system, such as system 200, various actions or events that affect the system's 200 configuration may take place.

In accordance with one aspect of system 200, controllers 230A and 230B include logic for configuring the status of BCCs 202A and 202B depending on the type of action or event taking place. These actions or events can include: attaching or removing one or more peripheral devices to or from system 200; attaching or removing one or more controller cards to or from system 200; removing or attaching a cable to backplane 206; and powering up system 200.

BCCs 202A and 202B can be fabricated using single or multi-layered printed circuit board(s), with the layers being designed to accommodate the required impedance for connections to host computers 204 and backplane 206. In some embodiments, BCCs 202A and 202B handle only differential signals, such as LVD signals to eliminate requirements for supporting single ended (SE) signals, thereby simplifying impedance matching considerations. Additionally, some embodiments of BCCs 202A and 202B allow data path signal traces on either internal layers or the external layers of the PCB, but not both, to avoid speed differences in the data signals. The width of the data signal traces on the BCC PCBs can be varied to match impedances at host connector portions 226A through 226D, and at backplane connector portions 224A through 224D.

A and B buses 212 and 214 on backplane 206 enable data communication between peripheral devices 1 through 14 and host computing systems, e.g., host computers 204, functionally coupled to backplane 206 via BCCs 202A, 202B. BCCs 202A and 202B, as well as A and B buses 212 and 214, can communicate using the SCSI communication protocol or other protocol. In some embodiments, A and B buses 212 and 214 are low voltage differential (LVD) Ultra-4 or Ultra-320 SCSI buses, for example. Alternatively, system 200 may include other types of communication interfaces and operate in accordance with other communication protocols.

A bus 212 and B bus 214 include a number of ports 226 and 228, respectively. Ports 226 and 228 can each have the same physical configuration. Peripheral devices 1 through 14, such as disk drives, for example, are adapted to communicate with ports 226, 228. The arrangement, type, and number of ports 226, 228 between buses 212, 214 may be configured in other arrangements and are not limited to the embodiment illustrated in FIG. 2A.

In some embodiments, connector portions 220A and 220C are electrically connected to A bus 212, and connector portions 220B and 220D are electrically connected to B bus 214. Connector portions 220A and 220B are physically and electrically configured to receive a first bus controller card, such as BCC 202A. Connector portions 220C and 220D are physically and electrically configured to receive a second bus controller card, such as BCC 202B.

BCCs 202A and 202B respectively include transceivers that can convert voltage levels of differential signals to the voltage level of signals utilized on a single-ended bus or can only recondition and resend the same signal levels. Terminators 222 can be connected to backplane connectors 210A through 210D to signal the terminal end of buses 212, 214. To work properly, terminators 222 use “term power” from bus 212 or 214. Term power is typically supplied by the host adapter and by the other devices on bus 212 and/or 214 or in this case power is supplied by a local power supply. In one embodiment, terminators 222 can be model number DS2108 terminators from Dallas Semiconductor.

In one or more embodiments, BCCs 202A, 202B include connector portions 224A through 224D, which are physically and electrically adapted to mate with backplane connector portions 210A through 210D. Backplane connector portions 210A through 210D and connector portions 224A through 224D should be impedance controlled connectors designed for high speed digital signals. In one embodiment, connector portions 224A through 224D are 120 pin count Methode/Teradyne connectors.

In certain embodiments, one of BCC 202A or 202B assumes primary status and acts as the central control logic unit that manages the configuration of system 200's components. When two or more BCCs are included in system 200, system 200 can be implemented to give primary status to a BCC in a predesignated slot. The primary and non-primary BCCs are substantially physically and electrically the same, with “primary” and “non-primary” denoting functions of the bus controller cards rather than unique physical configurations. Other schemes for designating primary and non-primary BCCs can be utilized.

In some embodiments, the primary BCC is responsible for configuring buses 212, 214, as well as providing other services such as bus addressing. The non-primary BCC is not responsible for configuring buses 212, 214, and responds to bus operation commands from the primary card, instead of initiating those commands itself. In other embodiments, the primary and non-primary BCCs can configure buses 212, 214, and initiate, as well as respond to, bus operation commands.

Typically, BCCs 202A and 202B can be hot-swapped, which is the ability to remove and replace BCC 202A and/or 202B without interrupting operation of communication system 200. The interface architecture of communication system 200 allows BCC 202A to monitor the status of BCC 202B, and vice versa. In some circumstances, such as hot-swapping, BCCs 202A and/or 202B perform fail-over activities to provide robust system performance. For example, when BCC 202A or 202B is removed or replaced, is not fully connected, or experiences a fault condition, the other BCC performs functions such as determining whether a change in a bus controller card's primary or non-primary status is required, setting signals to activate fault indications, and resetting BCC 202A or 202B. It should be noted that when more than two BCCs are included in system 200, the number and interconnections between buses on backplane 206 can vary accordingly.

Host connector portions 226A, 226B are electrically connected to BCC 202A. Similarly, host connector portions 226C, 226D are electrically connected to BCC 202B. Host connector portions 226A through 226D are adapted, respectively, for connection to a host device, such as host computers 204, for example. Host connector portions 226A through 226D receive voltage-differential input and transmit voltage-differential output. BCCs 202A and 202B can provide an independent channel of communication between each host computer 204 and communication buses 212, 214 implemented on backplane 206. In some embodiments, host connector portions 226A through 226D are implemented with connector portions that conform to the Very High Density Cable Interconnect (VHDCI) connector standard. Other suitable connectors that conform to other connector standards can be utilized.

Card controllers 230A, 230B can be implemented with any suitable processing device, such as controller model number VSC205 from Vitesse Semiconductor Corporation in Camarillo, Calif. Card controllers 230A, 230B execute instructions to control BCC 202A, 202B; communicate status information and data to host computers 204 via a data bus, such as a SCSI bus; and can also support diagnostic procedures for various components of system 200.

BCCs 202A and 202B can include isolators/expanders 232A, 234A, and 232B, 234B, respectively, to isolate and retime data signals. An expander is a device that enables a user to expand bus capabilities. A user can extend cable lengths to greater distances via an expander/extender, and isolate bus segments via an expander/isolator. Expanders can also allow a user to increase the number of peripherals the system can access, and/or dynamically reconfigure components. For example, systems based on HVD SCSI can use differential expander/converters to allow a system to access a LVD driver in the manner of a HVD driver.

In some embodiments, isolators/expanders 232A, 234A can isolate A and B buses 212 and 214 from monitor circuitry on BCC 202A, while isolators/expanders 232B, 234B can isolate A and B buses 212 and 214 from monitor circuitry on BCC 202B. Expander 232A communicates with backplane connector 224A, host connector portion 226A, and card controller 230A, while expander 234A communicates with backplane connector 224B, host connector portion 226B and card controller 230A. On BCC 202B, expander 232B communicates with backplane connector 224C, host connector portion 226B, and controller 230B, while expander 234B communicates with backplane connector 224D, host connector portion 226D and controller 230B.

Expanders 232A, 234A, 232B, and 234B support installation, removal, or exchange of peripherals while the system remains in operation. An isolation function monitors and protects host computers 204 and other devices by delaying the actual power up/down of the peripherals until an inactive time period is detected between bus cycles, thus preventing interruption of other bus activity. This feature also prevents power sequencing from generating signal noise, which can prevent data signal corruption. In some embodiments, expanders 232A, 234A, and 232B, 234B are implemented in an integrated circuit from LSI Logic Corporation in Milpitas, Calif., such as part numbers SYM53C180 or SYM53C320, depending on the data transfer speed. Other suitable devices can be utilized. Expanders 232A, 234A, and 232B, 234B can be placed as close as possible to backplane connector portions 224A through 224D to minimize the length of data bus signal traces 238A, 240A, 238B, and 240B.

The impedance for the front end data path traces from host connector portions 226A and 226B to card controller 230A is designed to match a cable interface having a measurable coupled differential impedance, for example, of 135 ohms. The impedance for the back end data path traces from expanders 232A and 234A to backplane connector portions 224A and 224B typically differs from the front end data path impedance, and may only be required to match a single-ended impedance, for example, of 67 ohms, which provides a decoupled differential impedance of 134 ohms. The layers of the printed circuit board (PCB) on which the BCCs 202A, 202B are implemented can be stacked to allow both types of traces to be provided on the same layers by simply changing the width of the traces to meet the impedance requirements.

In some embodiments, single ended devices are not allowed to be connected on the front end or the back end, thereby allowing the impedance for the differential traces to be based on the differential requirements only, instead of both the differential and single ended requirements. Some embodiments also require data path signals to be provided on either internal layers (referred to as “striplines”) or the outer layers (referred to as “microstrips”) of the BCC's PCB, but do not allow a mixture of stripline and microstrip data path signals to be used. The BCC's PCB is typically sized to allow use of standard mechanical interfaces, such as connectors and other standard interface cards.

In the embodiment shown in FIG. 2A, buses 212 and 214 are each divided into three segments on BCCs 202A and 202B, respectively. A first bus segment 236A is routed from host connector portion 226A to expander 232A to card controller 230A, to expander 234A, and from expander 234A to host connector portion 226B. A second bus segment 238A is connected between expander 232A and backplane connector portion 224A, and a third bus segment 240A is connected between expander 234A and backplane connector portion 224B. This architecture allows BCC 202A to connect to buses 212, 214 on backplane 206 if both isolators/expanders 232A and 234A are activated, or to connect to one bus on backplane 206 if only one expander 232A or 234A is activated. A similar data bus structure can be implemented on other BCCs, such as BCC 202B, which is shown with bus segments 236B, 238B, and 240B corresponding to bus segments 236A, 238A, and 240A on BCC 202A. BCCs 202A and 202B respectively can include transceivers (not shown) to convert the voltage levels of differential signals to the voltage level of signals utilized on buses 236A and 236B.

System 200 can operate in full bus or split bus mode. In full bus mode, all peripherals 1-14 can be accessed by the primary BCC, and the Non-primary BCC if available. The non-primary BCC assuming Primary functionality in the event of Primary failure. In split bus mode, one BCC accesses data through a subset of peripherals 1-14 on A bus 212 while the other BCC accesses a mutually exclusive subset of peripherals 1-14 through B bus 214. In some embodiments, a high and low address bank for each separate bus 212, 214 on backplane 206 can be utilized. In other embodiments, each slot 208A, 208B on backplane 206 is assigned an address to eliminate the need to route address control signals across backplane 206. In split bus mode, monitor circuitry utilizes an address on backplane 206 that is not utilized by any of peripherals 1 through 14. For example, SCSI bus typically allows addressing up to 15 peripheral devices. One of the 15 addresses can be reserved for use by the monitor circuitry on BCCs 202A, 202B to communicate operational and status parameters to Hosts 204. BCCs 202A and 202B communicate with each other over out of band serial buses such as general purpose serial I/O bus.

When BCCs 202A and 202B are connected to backplane 206, system 200 operates in full bus mode with the separate buses 212, 214 on backplane 206 connected together. The non-primary BCC defined does not receive commands directly from bus 212 or 214 since the bus commands are sent to the non-primary BCC from the primary BCC. Other suitable addressing and command schemes can be utilized. Various configurations of host computers 204 and BCCs 202A, 202B can be included in system 200, such as, for example:

two host computers 204 connected to a single BCC in full bus mode;

two BCCs in full or split bus mode and two host computers 204, with one of host computers 204 connected to one of the BCCs, and the other host computer 204 connected to the other BCC; and

two BCCs in full or split bus mode and four host computers 204, such as shown in FIG. 2A.

In some embodiments, backplane 206 may be included in a Hewlett-Packard DS2300 disk enclosure and may be adapted to receive DS2300 bus controller cards, for example. The DS2300 controller cards utilize a low voltage differential (LVD) interface to the buses 212 and 214.

FIG. 2B show an embodiment of system 200 with components for monitoring enclosure 242 and the operation of BCCs 202A and 202B including card controllers 230A, 230B; sensors modules 246A, 246B; backplane controllers (BPCs) 248A, 248B; card identifier modules 250A, 250B; backplane identifier module 252; flash memory 252A, 252B; serial communication connector port 256A, 256B, such as an RJ12 connector port; and interface protocol handlers such as RS-232 serial communication protocol handler 254A, 254B, and Internet Control Message Protocol handler 258A, 258B. Together, these components monitor the status of and configuration of enclosure 242 and BCCs 202A, 202B; provide status information to card controllers 230A, 230B, and to host computers 204; and control configuration and status indicators. In some embodiments, the monitor circuitry components on BCCs 202A, 202B communicate with card controllers 230A, 230B via a relatively low-speed system bus, such as an Inter-IC bus (I2C). Other suitable data communication infrastructures and protocols can be utilized.

Status information can be formatted using standardized data structures, such as SCSI Enclosure Services (SES) and SCSI Accessed Fault Tolerant Enclosure (SAF-TE) data structures. Messaging from enclosures that are compliant with SES and SAF-TE standards can be translated to audible and visible notifications on enclosure 242, such as status lights and alarms, to indicate failure of critical components. One or more switches can be provided on enclosure 242 to allow an administrator to enable the SES, SAF-TE, or other monitor interface scheme.

Voltage, fan speed, temperature, and other parameters at BCCs 202A and 202B can be monitored by sensor modules 246A, 246B. One such set of sensors that is suitable for use as sensor modules 246A, 246B is model number LM80, which is commercially available from National Semiconductor Corporation in Santa Clara, Calif. In some embodiments, the Intelligent Platform Management Interface (IPMI) specification can be used to provide a standard interface protocol for sensor modules 246A and 246B. Other suitable sensor modules and interface specifications can be utilized.

Backplane controllers 248A, 248B interface with card controllers 230A, 230B, respectively, to provide control information and report on the configuration of system 200. In some embodiments, backplane controllers 248A, 248B are implemented with backplane controller model number VSC055 from Vitesse Semiconductor Corporation in Camarillo, Calif. in combination with FPGA/PLDs that are used to monitor and react to time sensitive signals. Other suitable components can be utilized to perform the functions of backplane controllers 248A, 248B. Signals input to and output from backplane controllers 248A, 248B can include, among others: disk drive detection; identification of the primary or non-primary status of BCCs 202A, 202B; enabling or disabling expanders 232A, 234A, 232B, 234B; disk drive fault indicators; audible and visual enclosure (chassis) indicators; bus controller card fault detection; bus reset control enable; and power supply voltage and fan status.

Card identifier modules 250A, 250B provide information, such as serial and product numbers, of BCCs 202A and 202B to card controllers 230A, 230B. Backplane identifier module 266 also provides information about backplane 206, such as serial and product number, to card controllers 230A, 230B. In some embodiments, identifier modules 250A, 250B, and 266 are implemented with an electronically erasable programmable read only memory (EEPROM) and conform to the Field Replaceable Unit Identifier (FRU-ID) standard. Field replaceable units (FRU) include items which are hot swappable and can be individually replaced by a field engineer. A FRU-ID code can be included in an error message or diagnostic output indicating the physical location of a system component such as a power supply or I/O port. Other suitable identifier mechanisms and standards can be utilized for identifier modules 250A, 250B, and 266.

RJ-12 connector 256A allows connection to a diagnostic port in card controller 230A, 230B to access troubleshooting information and to download software and firmware instructions. RJ-12 connector 256A can also be used for an ICMP interface for test purposes.

Card controllers 230A and 230B can share data that assists monitoring degradation and potential failure of components in system 200. Monitor data buses 260 and 262 transmit data between card controllers 230A and 230B across backplane 206. The data exchanged between controllers 230A and 230B can include, among other signals, a periodic “heartbeat” signal from each controller 230A, 230B to the other to indicate that the other is operational, and a reset signal that allows a faulted BCC to be reset by another BCC. If the heartbeat signal is lost in the primary BCC, the non-primary BCC assumes the responsibilities of the primary BCC. The operational status of power supply 264A and a cooling fan (not shown) can also be transmitted periodically to controller 230A via bus 260. Similarly, bus 260 can transmit the operational status of power supply 264B and the cooling fan to controller 230B. In some embodiments, monitor data bus 260 is dedicated to transmitting data regarding power supplies 264A, 264B, while monitor data bus 262 is dedicated to transmitting heartbeat signals directly between card controllers 230A and 230B.

Warnings and alerts can be issued by any suitable method such as indicator lights on enclosure 242, audible tones, and messages displayed on a system administrator's console. In some embodiments, buses 260 and 262 can be implemented with a relatively low-speed system bus, such as an Inter-IC bus (I2C). Other suitable data communication infrastructures and protocols can be utilized in addition to, or instead of, the I2C standard.

Panel switches (not shown) and internal switches (not shown), may be also included on enclosure 242 for BCCs 202A and 202B. The switches can be set in various to configurations, such as split bus or full bus mode, to enable the desired functionality within system 200.

Referring to FIG. 2C, one or more logic units can be included on BCCs 202A and 202B, such as FPGA 254A, to perform time critical tasks. For example, FPGA 254A can generate reset signals and control enclosure indicators to inform system 200 or an administrator of certain conditions so that processes can be performed to help prevent loss or corruption of data. Such conditions may include, for example, insertion or removal of a BCC in system 200; insertion or removal of a peripheral; imminent loss of power from power supply 264A or 264B; loss of term power; and the removal of a cable from one of host connector portions 226A through 226D.

The instructions in FPGAs 254A, 254B can be updated by corresponding card controller 230A, 230B or other suitable means. Card controllers 230A, 230B and FPGAs 254A, 254B can monitor each other's operating status and assert a fault indication, as required, in the event non-operational status is detected. In some embodiments, FPGAs 254A, 254B includes instructions to assert the bus reset signal upon the occurrence of specified events such as insertion/removal of a peripheral, a second BCC, imminent loss of power, loss of term power, and removal of a cable or terminator from a connector. FPGAs 254A, 254B can also include instructions to perform various other functions such as resetting expanders 232A, 234A, 232B, 234B, and driving system status indicators

A clock signal can be supplied by one or more of host computers 204 or generated by an oscillator (not shown) implemented on BCCs 202A and 202B. The clock signal can be supplied to any component on BCCs 202A and 202B.

Various embodiments of BCCs 202A and 202B provide advantages over known BCCs by enabling communication of high speed signals across separate buses 212, 214 on backplane 206. Alternatively, high speed signals from host connector portions 226A and 226B, or 226C and 226D, can be communicated across only one of buses 212, 214.

High speed data signal integrity can be optimized in illustrative BCC embodiments by matching impedance and length of the traces for data bus segments 236A, 238A, and 240A across one or more PCB routing layers. Trace width can be varied to match impedance and trace length varied to match electrical lengths, improving data transfer speed. Signal trace stubs to components on BCC 202A can be reduced or eliminated by connecting signal traces directly to components rather than by tee connections. Length of bus segments 238A and 240A can be reduced by positioning expanders 232A and 234A as close to backplane connector portions 224A and 224B as possible.

In some embodiments, two expanders 232A, 234A on the same BCC 202A can be enabled simultaneously, forming a controllable bridge connection between A bus 212 and B bus 214, eliminating the need for a dedicated bridge module.

The logic modules and circuitry described here may be implemented using any suitable combination of hardware, software, and/or firmware, such as Field Programmable Gate Arrays (FPGAs), Application Specific Integrated Circuit (ASICs), or other suitable devices. A FPGA is a programmable logic device (PLD) with a high density of gates. An ASIC is a microprocessor that is custom designed for a specific application rather than a general-purpose microprocessor. The use of FPGAs and ASICs improves the performance of the system over general-purpose CPUs, because these logic chips are hardwired to perform a specific task and do not incur the overhead of fetching and interpreting stored instructions. The logic modules can be independently implemented or included in one of the other system components such as controllers 230A and 230B. Similarly, other components on BCCs 202A and 202B have been discussed as separate and discrete components. These components may, however, be combined to form larger or different integrated circuits or electrical assemblies, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims.

In the claims, unless otherwise indicated the article “a” is to refer to “one or more than one”.

1. A communication system comprising:
a dual ported bus interface;
a controller coupled to the dual ported bus interface, the dual ported bus interface having first and second front end ports capable of connecting to host bus adapters, first and second expanders coupled to the first and second front end ports, first and second backplane connectors for insertion into a selected slot of first and second slots and coupling to one or more buses on the backplane, and interconnections for coupling signals from the first and second front end ports through the expanders to the backplane buses; and
a programmable code executable on the controller and further comprising:
a programmable code that detects interface status, bus configuration, and connection status of the front end ports; and
a programmable code that controls the state of the reset signal based on the detected interface status, bus configuration, and connection status.

2. The communication system according to claim 1 further comprising:
a programmable code executable on the controller that selectively holds and releases the reset signal based on the detected interface status, bus configuration, and connection status.

3. The communication system according to claim 1 further comprising:
a programmable code executable on the controller that detects the interface status from among primary and non-primary states.

4. The communication system according to claim 1 further comprising:
a programmable code executable on the controller that detects the bus configuration from between split bus and full bus configurations.

5. The communication system according to claim 1 further comprising:
a programmable code executable on the controller that detects the connection status from between proper and improper.

6. The communication system according to claim 2 further comprising:
a programmable code that detects the presence of a peer bus interface.

7. The communication system according to claim 6 further comprising:
a programmable code that detects whether the system is configured to allow bus resets.

8. The communication system according to claim 7 further comprising:
a programmable code executable on the controller that holds the reset signal in conditions of:
the peer bus interface is removed;
the bus resets are allowed;
the interface status is non-primary state; and
the bus configuration is full bus and connection status is improper; and the programmable code otherwise releases the reset signal.

9. The communication system according to claim 7 further comprising:
a programmable code executable on the controller that holds the reset signal in conditions of:
the expanders are enabled and the bus configuration is full bus;
the connection status is improper; and
the interface status is primary state; and the programmable code otherwise releases the reset signal.

10. A dual ported bus interface comprising:
first and second front end ports capable of connecting to a host device;
first and second expanders coupled to the first and second front end ports;
first and second backplane connectors for insertion into a selected slot of first and second slots and coupling to one or more buses on the backplane;
a controller coupled to the first and second expanders for communicating signals from the first and second front end ports through the expanders to the backplane buses, the controller being capable of detecting interface status, bus configuration, and front end port connection status, and capable of holding and releasing a bus reset signal based on the detected interface status, bus configuration, and front end port connection status.

11. The bus interface according to claim 10 wherein the controller is further capable of detecting peer interface status, and holding and releasing the bus reset signal based on the detected peer interface status.

12. The bus interface according to claim 10 wherein the controller is further capable of detecting the interface status from among primary and non-primary states.

13. The bus interface according to claim 10 wherein the controller is further capable of detecting the bus configuration from between split bus and full bus configurations.

14. The bus interface according to claim 10 wherein the controller is further capable of detecting the connection status from between proper and improper.

15. The bus interface according to claim 11 wherein the controller is further capable of detecting the presence of a peer bus interface.

16. The bus interface according to claim 15 wherein the controller is further capable of detecting whether the system is configured to allow bus resets.

17. The bus interface according to claim 10 wherein the controller is further capable of holding the reset signal in conditions of:
a peer bus interface is removed;
bus resets are allowed;
the interface status is non-primary state; and
the bus configuration is full bus and connection status is improper; and the programmable code otherwise releases the reset signal.

18. The bus interface according to claim 16 wherein the controller is further capable of holding the reset signal in conditions of:
the expanders are enabled and the bus configuration is full bus;
the connection status is improper; and
the interface status is primary state; and the programmable code otherwise releases the reset signal.

19. A method of asserting a reset signal in a dual ported bus interface comprising:
detecting status of the bus interface from among a primary state and a non-primary state;
determining a configuration of the bus interface between a full bus configuration and a split bus configuration;
detecting status of a connection to the bus interface; and
asserting and releasing the reset signal based on the detected interface status, the bus configuration, and the connection status.

20. The method according to claim 19 further comprising asserting the reset signal in conditions of:
a peer bus interface is removed;
bus resets are allowed;
the interface status is non-primary state; and
the bus configuration is full bus and connection status is improper.

21. The method according to claim 20 further comprising:
releasing the bus reset signal after a fixed period of time under other conditions.

22. The method according to claim 19 further comprising asserting the reset signal in conditions of:
expanders on the bus interface are enabled and the bus configuration is full bus;
the connection status is improper; and
the interface status is primary state.

23. The method according to claim 19 further comprising:
detecting the status of a bus reset enable switch; and
asserting and releasing the reset signal based on the bus reset enable switch setting.

24. A dual ported bus interface comprising:
means for detecting status of the bus interface from among a primary state, and a non-primary state;
means for determining a configuration of the bus interface between a full bus configuration and a split bus configuration;
means for determining status of a connection to a port on the front end of the bus interface; and
means for asserting and releasing a reset signal based on the bus interface status, the bus interface configuration, and the status of the connection.
